(19) United States
(12) Patent Application Publication
(10) Pub. No.: US 2005/0005167 A1
(43) Pub. Date: Jan. 6, 2005

(54) Systems and methods for providing security operations in a work machine

(76) Inventors: Thomas J. Kelly, Dunlap, IL (US); Daniel C. Wood, East Peoria, IL (US); Alan L. Ferguson, Peoria, IL (US); Paul W. Bierdeman, East Peoria, IL (US); Brian L. Jenkins, Washington, IL (US); Trent R. Meiss, Eureka, IL (US); Andrew J. Swanson, Peoria, IL (US)

Correspondence Address: Finnegan, Henderson, Farabow,;Garrett & Dunner, L.L.P., 1300 I Street, N.W., Washington, DC, 20005-3315, US

(21) Appl. No.: 10/646,714

(22) Filed: Aug. 25, 2003

Related U.S. Application Data
(60) Provisional application No. 60/483,915, filed on Jul. 2, 2003.

(51) Int. Cl. H04L 9/00

(52) U.S. Cl. 713/201

(57) ABSTRACT

A method and system are provided to perform a process of managing communications in an environment including a work machine having one or more on-board data links connected to one or more on-board modules and a gateway, and one or more off-board data links connected to one or more off-board systems and the gateway. In one embodiment, the process includes receiving a request generated by a first off-board system and transmitted on a first off-board data link and invoking a firewall application that performs a firewall process. The firewall process may include identifying a destination device associated with the request and determining whether the request is authorized based on a profile associated with the first off-board system. Also, the process may include determining whether the request includes a parameter identifier that matches a parameter identifier included in a memory location maintained by the gateway, and based on the profile and parameter identifier determinations, denying or granting access to proprietary information associated with the work machine.

### CROSS REFERENCE TO RELATED APPLICATIONS

This application claims the benefit of U.S. Provisional Application Ser. No. 60/483,915 entitled “Systems and Methods for Interfacing Off-Board and On-Board Networks in a Work Machine,” filed Jul. 2, 2003, owned by the assignee of this application and expressly incorporated herein by reference in its entirety.

This application is related to U.S. application Ser. No. ______, entitled “SYSTEMS AND METHODS FOR PROVIDING SERVER OPERATIONS IN A WORK MACHINE,” filed Aug. 25, 2003, U.S. application Ser. No. ______, entitled “SYSTEMS AND METHODS FOR PERFORMING PROTOCOL CONVERSIONS IN A WORK MACHINE,” filed Aug. 25, 2003, U.S. application Ser. No. ______, entitled “SYSTEMS AND METHODS FOR PROVIDING NETWORK COMMUNICATIONS BETWEEN WORK MACHINES,” filed Aug. 25, 2003, and U.S. application Ser. No. ______, entitled “METHODS AND SYSTEMS FOR PROVIDING PROXY CONTROL FUNCTIONS IN A WORK MACHINE,” filed Aug. 25, 2003, each owned by the assignee of this application and expressly incorporated herein by reference in its entirety.

### TECHNICAL FIELD

This invention relates generally to network interface systems and more particularly, to systems and methods for providing gateway security/server operations in a work machine.

### BACKGROUND

An important feature in modern work machines (e.g., fixed and mobile commercial machines, such as construction machines, fixed engine systems, marine-based machines, etc.) is the on-board electronic communications, monitoring, and control network. An on-board network includes many different modules connected to different types of communication links. These links may be proprietary and non-proprietary, such as manufacturer-based data links and communication paths based on known industry standards (e.g., J1939, RS-232, RP1210, RS-422, RS-485, MODBUS, CAN, etc.). Other features implemented with work machines are off-board networks, such as wireless networks (e.g., cellular), satellite networks (e.g., GPS), and TCP/IP-based networks.

On-board modules may communicate with other on-board or off-board modules to perform various functions related to the operation of the work machine. For example, display modules may receive sensor data from an engine control module via a J1939 data link, while another control module connected to a proprietary data link may provide data to another module connected to the same link. Also, an on-board module may send data to an off-board system using a different communication path extending from the work machine to the off-board system.

Problems arise, however, when modules connected to different types of data links need to communicate. To address these problems, conventional systems may incorporate various interface devices to facilitate communications between different types of data links. Although this solution may be functionally acceptable in some instances, their implementations are restricted due to the hardware and service capabilities associated with the types of data links used in a work machine. Further, the additional hardware may take up valuable space needed for other components used by the machine.

One of these components is the machine's on-board computer system. Today, work machines must not only include various interface devices for facilitating communications in multi-protocol environments, but they require the processing capabilities to service this traffic. Further, the complexity and applications of work machines require these machines to provide other types of data management services. However, work machines have limitations when accessing off-board resources to provide these services. For example, conventional machines may require information from a remote site to perform on-site operations. To obtain this information, these systems may have limited options, such as the operator contacting the remote site via wireless networks (e.g., user cellphone) and taking the machine to a site where the information may be downloaded to the machine (e.g., a diagnostic or data download center).

U.S. Pat. No. 6,202,008 to Beckert et al. addresses this problem by offering a vehicle computer system that runs a multi-tasking operating system. The system executes multiple applications including vehicle and non-vehicle related software. These applications may use a wireless link to gain access to the Internet and its resources. Also, the computer system may provide server applications to distribute data to other on-board components. Although Beckert et al. provides a solution to the afore-mentioned problems associated with external resources, it does so at the cost of additional components. That is, Beckert et al. requires three modules, i.e., a support module, a computer module, and a faceplate module, to facilitate its server capabilities. Accordingly, the system falls short of alleviating the problems of providing a on-board system that can provide data management and interface capabilities with minimal hardware and software components.

In addition to the shortcomings associated with resource accessibility, problems arise when unauthorized entities gain access to work machines using the interface mechanisms operating within these machines. In particular, conventional work machines do not have mechanisms in place that monitor and control access to proprietary information associated with the work machine. Accordingly, unauthorized users may gain access to a work machine's on-board modules that maintain data that is used to control operations of the machine. This may result in unacceptable and, in some instances, illegal operations of the work machine, and in unauthorized access to secure information, such as proprietary parameter codes.

U.S. Pat. No. 6,314,351 to Chutorash attempts to address some security issues associated with vehicle computer systems by implementing a firewall between a vehicle computer and vehicle components. The firewall controls access to the vehicle components by on-board application programs running in the vehicle computer. Although Chutorash provides security features to protect vehicle components from unauthorized operations, the system falls short in addressing the problems associated with unauthorized access to on-board modules by off-board systems and/or users.

Methods, systems, and articles of manufacture consistent with certain embodiments of the present invention are directed to solving one or more of the problems set forth above.

### SUMMARY OF THE INVENTION

A method is provided for managing communications in an environment including a work machine having one or more on-board data links connected to one or more on-board modules and a gateway, and one or more off-board data links connected to one or more off-board systems and the gateway. In one embodiment, the method includes receiving a request generated by a first off-board system and transmitted on a first off-board data link and invoking a firewall application that performs a firewall process. The firewall process may include identifying a destination device associated with the request and determining whether the request is authorized based on a profile associated with the first off-board system. Also, the process may include determining whether the request includes a parameter identifier that matches a parameter identifier included in a memory location maintained by the gateway, and based on the profile and parameter identifier determinations, denying or granting access to proprietary information associated with the work machine.

In another embodiment, a system is provided for managing communications between one or more on-board modules connected to one or more on-board data links and one or more off-board systems connected to one or more off-board data links. The system may include a first off-board system connected to a first off-board data link, wherein the off-board module is remotely located from the work machine and a gateway embedded in the work machine. The gateway may include a communication application that uses a translation table stored in the gateway for converting information from a first protocol format to a second protocol format. Also, the gateway includes a firewall application that is configured to perform, when executed by a processor, a firewall process that controls access to proprietary information associated with the work machine. The firewall process determines whether a message received from the first off-board module includes a parameter identifier corresponding to one of a number of parameter identifiers included in the translation table stored in the gateway, and denies access to the proprietary information based on a determination that the parameter identifier in the data message does not correspond to one of the number of parameter identifiers in the translation table.

### BRIEF DESCRIPTION OF THE DRAWINGS

The accompanying drawings, which are incorporated in and constitute a part of this specification, illustrate several aspects of the invention and together with the description, serve to explain the principles of the invention. In the drawings:

FIG. 1 illustrates a block diagram of an exemplary system that may be configured to perform certain functions consistent with embodiments of the present invention;

FIG. 2 illustrates a block diagram of an exemplary gateway consistent with embodiments of the present invention;

FIG. 3 illustrates a block diagram of an exemplary software architecture for a gateway consistent with embodiments of the present invention;

FIG. 4 illustrates a block diagram of an exemplary off-board server configuration consistent with embodiments of the present invention;

FIG. 5 illustrates a flowchart of an exemplary off-board server process consistent with embodiments of the present invention;

FIG. 6 illustrates a block diagram of an exemplary on-board server configuration consistent with embodiments of the present invention;

FIG. 7 illustrates a flowchart of an exemplary on-board server process consistent with embodiments of the present invention;

FIG. 8 illustrates a flowchart of an exemplary Web server process consistent with embodiments of the present invention;

FIG. 9 illustrates a block diagram of an exemplary translation table consistent with embodiments of the present invention;

FIG. 10 illustrates a flowchart of an exemplary translation process consistent with embodiments of the present invention; and

FIG. 11 illustrates a flowchart of an exemplary firewall application process consistent with embodiments of the present invention.

### DETAILED DESCRIPTION

Reference will now be made in detail to the exemplary aspects of the invention, examples of which are illustrated in the accompanying drawings. Wherever possible, the same reference numbers will be used throughout the drawings to refer to the same or like parts.

Overview

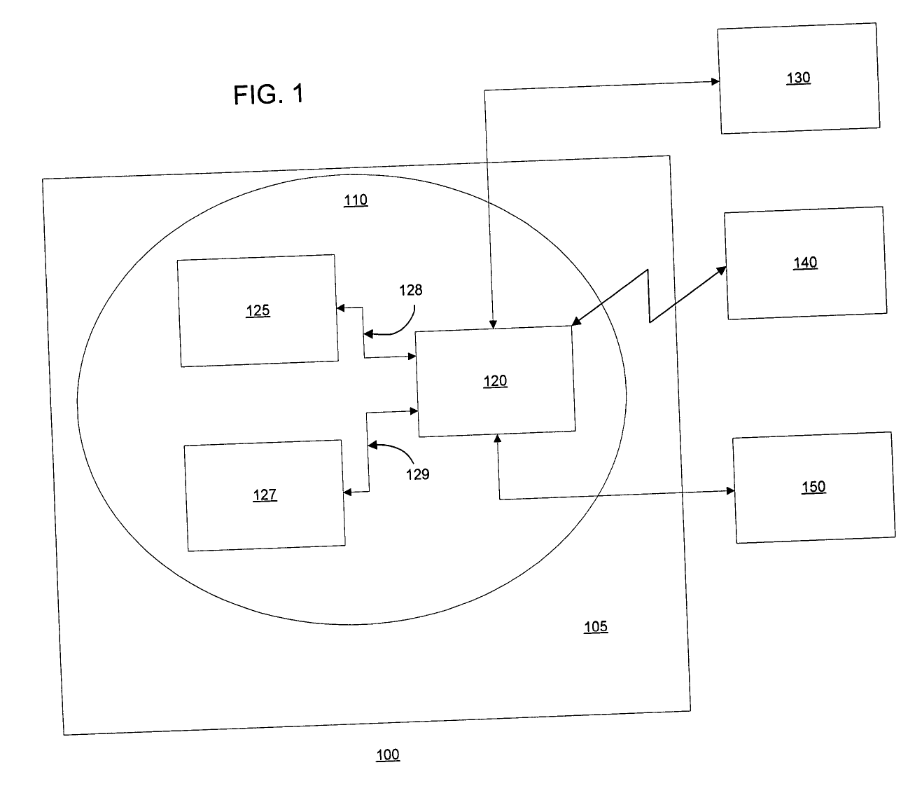

FIG. 1 illustrates an exemplary system 100 in which features and principles consistent with an embodiment of the present invention may be implemented. As shown in FIG. 1, system 100 may include a work machine 105 including an on-board system 110 comprising a gateway 120 and on-board modules 125, 127. System 100 may also include one or more off-board systems 130-150. Although gateway 120 is shown as a separate entity, methods and systems consistent with the present invention allow the gateway 120 to be included as a functional component of one or more of on-board modules 125 and 127.

A work machine, as the term is used herein, refers to a fixed or mobile machine that performs some type of operation associated with a particular industry, such as mining, construction, farming, etc. and operates between or within work environments (e.g., construction site, mine site, power plant, etc.). A non-limiting example of a fixed machine includes an engine system operating in a plant, off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment.

An on-board module, as the term is used herein, may represent any type of component operating in work machine 105 that controls or is controlled by other components or sub-components. For example, an on-board module may be an operator display device, an Engine Control Module (ECM), a power system control module, a Global Positioning System (GPS) interface device, an attachment interface that connects one or more sub-components, and any other type of device work machine 105 may use to facilitate operations of the machine during run time or non-run time conditions (i.e., machine engine running or not running, respectively).

An off-board system, as the term is used herein, may represent a system that is located remote from work machine 105. An off-board system may be a system that connects to on-board system 110 through wireline or wireless data links. Further, an off-board system may be a computer system including known computing components, such as one or more processors, software, display, and interface devices that operate collectively to perform one or more processes. Alternatively, or additionally, an off-board system may include one or more communications devices that facilitates the transmission of data to and from on-board system 110.

Gateway 120 represents one or more interface devices configured to perform functions consistent with various embodiments of the present invention. Gateway 120 may be configured with various types of hardware and software depending on its application within a work machine. Thus, in accordance with embodiments of the invention, gateway 120 may provide interface capability that facilitates the transmission of data to and from on-board system 110, performs various data processing functions, and maintains data for use by one or more on-board modules or off-board systems. For example, gateway 120 may be configured to perform protocol conversions (e.g., tunneling and translations), intelligent routing, and server-based operations, such as data provisioning, application provisioning, Web server operations, electronic mail server operations, data traffic management, and any other type of server-based operations that enable on-board system 110 to retrieve, generate, and/or provide data with on-board and/or off-board systems.

For clarity of explanation, FIG. 1 depicts gateway 120 as a distinct element. However, consistent with principles of the present invention, “gateway” functionality may be implemented via software, hardware, and/or firmware within one or more modules (e.g., 125, 127) on a network, which controls a system on a work machine and communicates with an off-board system. Thus, gateway 120 may, in certain embodiments, represent functionality or logic embedded within another element.

On-board module 125 represents one or more on-board modules connected to one or more proprietary data links 128 included in on-board system 110. On-board module 127 may be one or more on-board modules connected to a non-proprietary data link 129, such as Society of Automotive Engineers (SAE) standard data links including Controller Area Network (CAN), J1939, etc. standard data links. Data links 128 and 129 may be wireless or wireline. For example, in one embodiment, work machine 105 may include wireless sensors that are linked together through gateway 120.

As shown in FIG. 1, gateway 120 also interfaces with one or more off-board systems 130-150. In one exemplary embodiment, off-board systems 130-150 include, for example, computer system 130, computer system 140, and service port system 150.

Computer system 130 represents one or more computing systems each executing one or more software applications. For example, computer system 130 may be a workstation, personal digital assistant, laptop, mainframe, etc. Computer system 130 may include Web browser software that requests and receives data from a server when executed by a processor and displays content to a user operating the system. In one embodiment of the invention, computer system 130 is connected to on-board system 110 through one or more wireline based data links, such as a Local Area Network (LAN), an Extranet, and the Internet using an Ethernet connection based on TCP/IP.

Computer system 140 also represents one or more computing systems each executing one or more software applications. Computer system 140 may be a workstation, personal digital assistant, laptop, mainframe, etc. Also, computer system 140 may include Web browser software that requests and receives data from a server when executed by a processor and displays content to a user operating the system. In one embodiment of the invention, computer system 140 is connected to on-board system 110 through one or more wireless based data links, such as cellular, satellite, and radio-based communication data links.

Computer systems 130 and 140 may each be associated with a user (e.g., customer), multiple users, a business entity (dealer, manufacturer, vendor, etc.), a department of a business entity (e.g., service center, operations support center, logistics center, etc.), and any other type of entity that sends and/or receives information to/from on-board system 110. Further, computer system 130 and 140 may each execute off-board software applications that download or upload information to/from on-board system 110 via gateway 120.

In certain embodiments, computer systems 130 and 140 may include one or more controllers, such as Programmable Logic Controllers (PLCs) that may be used in plants and/or factories.

Service system 150 represent one or more portable, or fixed, service systems that perform diagnostics and/or service operations that include receiving and sending messages to on-board system 110 via gateway 120. For example, service port system 150 may be a electronic testing device that connects to on-board system 120 through an RS-232 serial data link. Using service port system 150, a user or an application executed by a processor may perform diagnostics and service operations on any of on-board system modules 125, 127 through gateway 120.

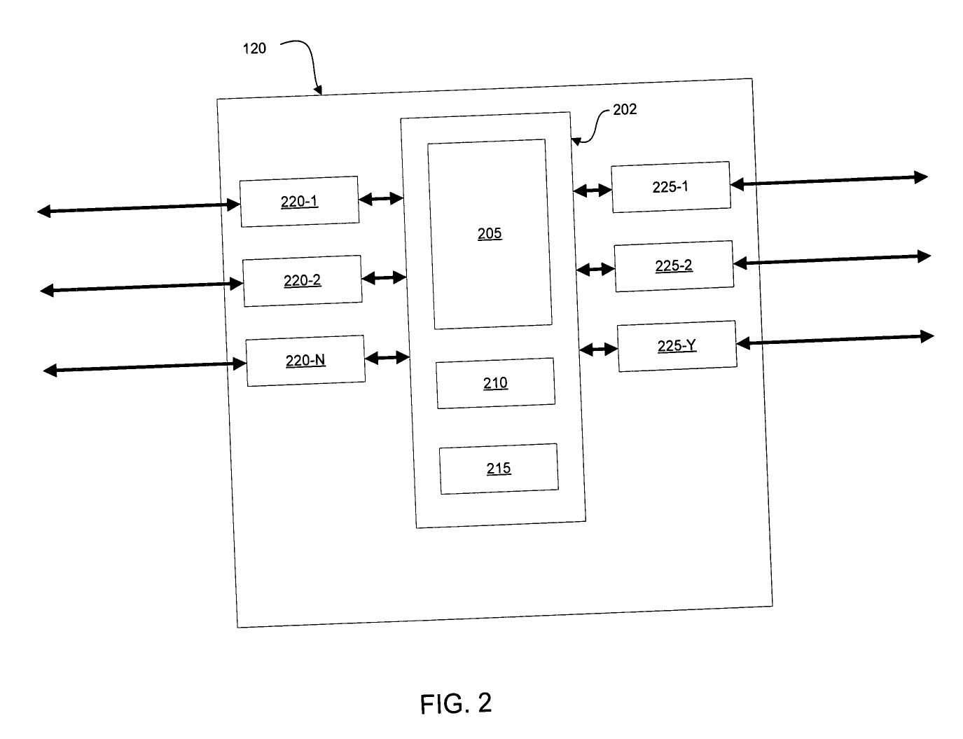

In one embodiment, gateway 120 may include various computing components used to perform server based services (e.g., communications services, file services, database services, etc.) for on-board system 110. FIG. 2 shows an exemplary block diagram of gateway 120 consistent with embodiments of the present invention. As shown, gateway 120 includes a digital core 202, on-board data link port components 220-1 to 220-N, and off-board data link port components 225-1 to 225-Y.

Digital core 202 includes the logic and processing components used by gateway 120 to perform its interface, communications, and server functionalities. In one embodiment, digital core 202 includes one or more processors 205 and internal memories 210 and 215. Processor 205 may represent one or more microprocessors that execute software to perform the gateway features of the present invention. Memory 210 may represent one or more memory devices that temporarily store data, instructions, and executable code, or any combination thereof, used by processor 205. Memory 215 may represent one or more memory devices that store data temporarily during operation of gateway 120, such as a cache memory, register devices, buffers, queuing memory devices, and any type of memory device that maintains information. Memories 210 and 215 may be any type of memory device, such as flash memory, Static Random Access Memory (SRAM), and battery backed non-volatile memory devices.

On-board data link ports 220-1 to 220-N represent one or more interface devices that interconnect one or more on-board data links with digital core 202. For example, on-board data link ports 220-1 to 220-N may connect to proprietary and non-proprietary data links 128, 129, respectively. In one embodiment, on-board data link ports 220-1 to 220-N interfaces with one or more proprietary data links, one or more CAN data links (e.g., J1939, galvanized isolated CAN data links, etc.), one or more RS-232 serial based data links (e.g., MODBUS, PPP, NMEA183, etc.), and one or more RS-232 data links. On-board data link ports 220-1 to 220-N may also include virtual (i.e., software) ports that allow a single connection to act as if there were multiple connections.

Off-board data link ports 225-1 to 225-Y represent one or more interface devices that interconnect one or more off-board data links with digital core 202. For example, off-board data link ports 225-1 to 225-Y may connect gateway 120 to one or more RS-232 data links, RS-485 data links, Ethernet data links, MODBUS data links, radio data links, infra-red data links, and/or satellite data links, etc. It is appreciated that gateway 120 may be configured to interface with any type of data link used in an on-board or off-board system network.

The gateway 120 shown in FIG. 2 is exemplary and not intended to be limiting. A number of additional components may be included in gateway 120 that supplement and/or compliment the operations of digital core 202 and data link ports 220 and 225. For example, gateway 120 may also include an internal power supply, a real time clock, hour meter, sensor inputs for receiving signals from one or more sensors monitoring the operations of a work machine component, memory arrays, etc. Moreover, as explained, gateway 120 may, in certain embodiments, be implemented (e.g., via logic and/or circuitry) within one or more modules coupled to a given network.

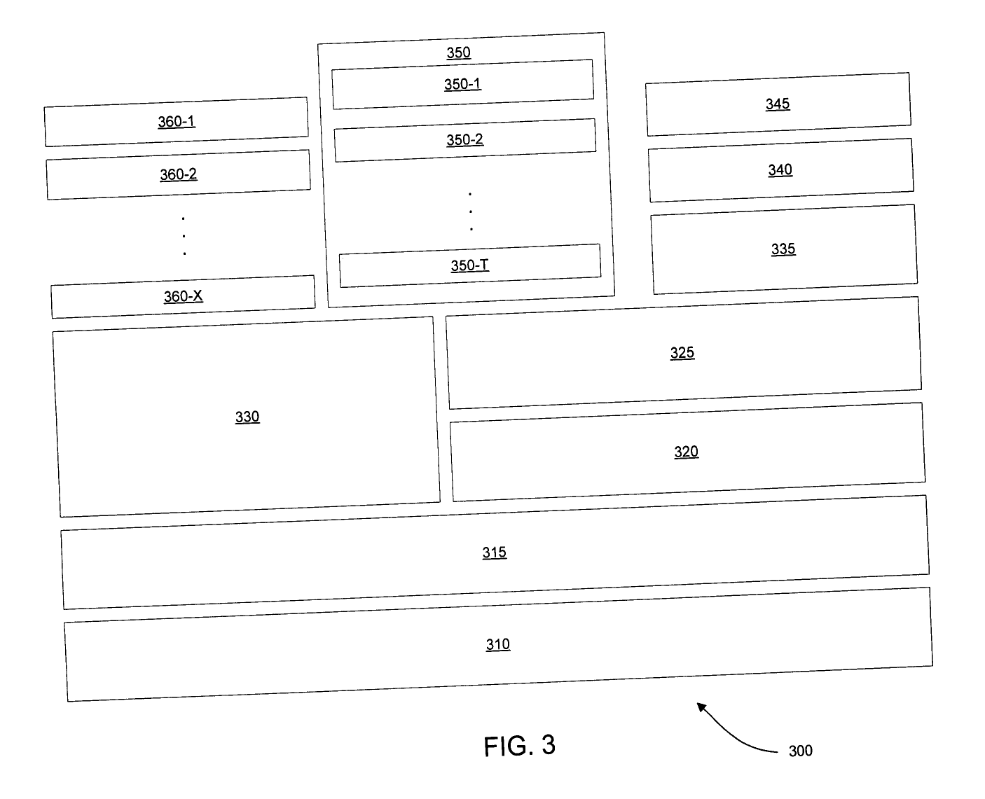

In operation, digital core 202 executes program code to facilitate communications between on-board modules and/or off-board systems. In one embodiment of the present invention, memory 210 includes application and server-based software programs that allow information received through either data link ports 220 and 225 to be processed and/or transferred to the proper destination module/system in the proper format. FIG. 3 illustrates an exemplary software architecture model 300 that may be implemented by gateway 120 consistent with embodiments of the present invention.

Exemplary model 300 may include hardware interface software, such as boot executable software and driver software layer 310, that drive the on-board and off-board data link ports 220 and 225 connecting the multiple types of data links to gateway 120 (e.g., Ethernet, RS-232, CAN, proprietary data links, etc.). A core hardware access layer 315 interfaces boot executable layer 310 and core software layer 330, which includes software associated with runtime operations of gateway 120. Layer 320 includes operating system software executed by processor 205, and layer 325 is a network stack level including one or more protocol stacks used to perform communication services, such as formatting data messages for specific protocols, etc. In one embodiment, model 300 may also include a Web server layer 335 that includes server software used by gateway 120 to perform Web server operations, such as HTML processing, content generation, Web page request processing, etc. Further, model 300 may also include one or more layers 340-360 representing application programs executable by gateway 120. For example, layers 340, 345 may represent server applications executed by gateway 120 to perform certain services, such as data provisioning, application management, traffic management, etc. Layers 360-1 to 360-X may represent application programs that perform operations associated with functions typically performed by certain types of on-board modules connected to an on-board network, such as a Customer Communication Module (CCM), a communication adapter, a GPS Interface Module (GPSINM), a third party interface software, an Engine Vision Interface Module (EVIM), and a product link module.

Model 300 may also include an inter-data link gateway layer 350 that includes one or more gateway applications 350-1 to 350-T, that perform protocol conversion operations for converting information associated with one type of data link to another. The conversion operations may include protocol translation and tunneling features. Processor 205 may execute a selected one of application programs 350-1 to 350-T based on the type of format required by an outgoing data link. For example, application layer 350-1 may represent a protocol conversion program that allows data messages received in a proprietary data link to be converted to a J1939 format for transmission across a J1939 data link. Other types of conversion applications may be configured in model 300 including application layers that combine one or more protocol conversion capabilities.

Embedded Server Applications

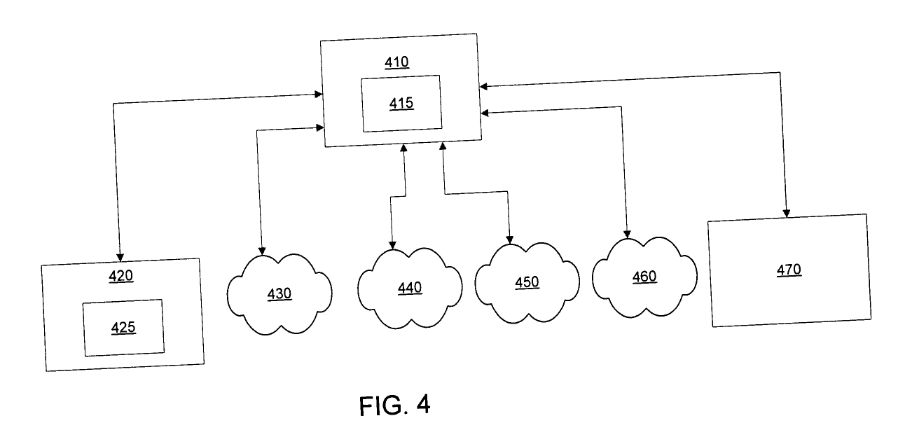

Methods and systems consistent with embodiments of the present invention may include one or more work machines that each include one or more gateways 120 that operate as an embedded server. In these embodiments, gateway 120 includes hardware and software that enable it to operate in a server-like fashion, receiving requests for information and servicing those requests. Gateway 120 may also operate as a Web server and execute application software (e.g., communication applications) during runtime operations to ensure the work machine receives and sends information in appropriate formats and to proper destinations. When embedded in a work machine, gateway 120 may operate as a server in manner by dynamically servicing requests from off-board systems. FIG. 4 illustrates a block diagram showing an exemplary off-board server system 400 consistent with embodiments of the present invention.

As shown in FIG. 4, a work machine 410 including a gateway 415, which may be configured, and operates, similarly to gateway 120 described in connection with FIGS. 1 and 2. Gateway 415 may execute one or more server applications that allow work machine 410 to communicate with one or more off-board elements, such as another work machine 420, a Wide Area Satellite Wireless Network (WASWN) 430, a Wireless Local Area Network (WLAN) 440, a Wide-Area Terrestrial Wireless Network (WATWLN) 450, a Wide Area Network (WAN) 460, and one or more external systems 470.

Work machine 420 may include a gateway 425 that may be configured, and operates, similar to gateway 120. Work machine 420 may be a mobile or fixed work machine connected to work machine 410 through a wireline or wireless data link. WASWN 430 may be a satellite radio network that includes infrastructure allowing communications between one or more satellite devices and a remote system, such as computer system 140 described in connection with FIG. 1. WLAN may be a wireless radio network including infrastructure that facilitates communications between one or more wireless radio devices and a remote system, such as computer system 140. WATWLN 450 may be a wireless network that includes infrastructure allowing communications between one or more cellular devices and a remote system (e.g., computer system 140). WAN 460 may be a network including the infrastructure that allows for Internet access, such as the World Wide Web. External system 470 may represent a remote system that communicates with gateway 415 through a wireless or wireline connection, such as computer system 130, computer system 140, or service port system 150.

Although FIG. 4 shows work machine 420 and external system 470 connected to work machine 410 through dedicated data links, these elements may also be configured to communicate with gateway 415 through one or more of networks 430, 440, 450, and 470.

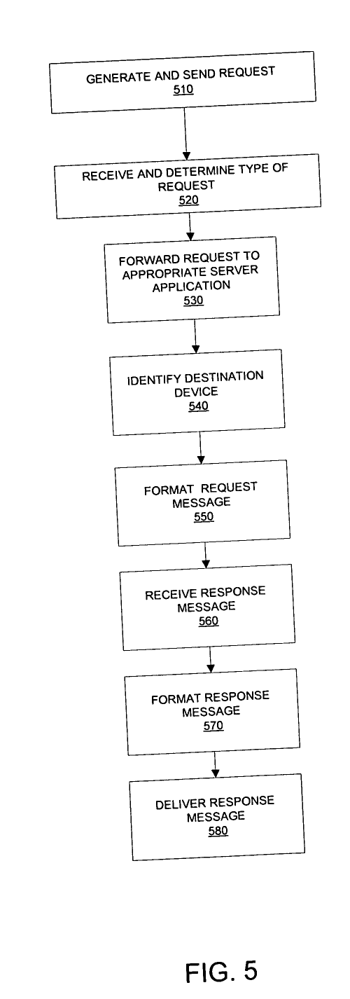

As an embedded server, gateway 415 may receive requests from any of the off-board elements shown in FIG. 4. FIG. 5 illustrates a flowchart of an exemplary off-board server process consistent with embodiments of the present invention. At step 510, a source device generates and sends a server request to gateway 415. The source device may be an off-board system communicating with any of the networks 430-460, work machine 420, or external system 470. Accordingly, the data link used to send the request depends on the type of source device and the data link used by the device to communicate with gateway 415.

At step 520, gateway 415 receives the request through the appropriate data link port (e.g., data link port 225-1 to 225-Y) and determines the type of request. The server request may be any type of request for information or services accessible or performed by gateway 415. For example, the server request may be a request for data stored in an internal memory (e.g., memory 215) of gateway 415. Alternatively, the server request may be a request for information stored in an on-board module included in an on-board system of work machine 410 (e.g., on-board module 125 or 127). Further, the server request may be a request to push information to gateway 425 of work machine 420 for delivery to a component within gateway 425 or elsewhere within machine 420 or to an on-board module within work machine 410. As can be appreciated, gateway 415 may receive many different types of server requests based on the source device generating the request and the information or services requested.

Based on the type of request received, gateway 415 passes the request to an appropriate server application that is configured to process the request (Step 530). For example, a request for information may be handled by a file server application, while a request for setting the work machine in a particular mode of operation (e.g., calibration mode) may be handled by another type of server application. Moreover, a request for passing data to a destination device may be handled by a communication server application that leverages one or more of inter-data link gateway applications 350 executed by gateway 415.

Once the proper server application receives the request, gateway 415 identifies the destination device associated with the type of request (Step 540). For example, a server request including instructions for collecting engine operations data may require information stored in an ECM included in the on-board system of work machine 410. Accordingly, the server application processing the request may identify the ECM as the destination device. However, if the server request is for information maintained by a memory device or program operating within gateway 415, the server application may identify the memory device or program as the destination device. Thus, a destination device may be a physical component operating within gateway 415 or work machine 410 or a software process executed by gateway 415.

In addition to identifying the destination device, the server application may also facilitate the conversion of the request to a format compatible with the destination device (Step 550). For example, a request for engine operations data from an ECM connected to a J1939 data link requires J1939 protocol to be used in transmitting the request. Accordingly, if necessary, the server application may use a protocol conversion application (e.g., inter-data link gateway applications 350-1 to 350-T) to convert the request message to J1939 format for transmission to the destination ECM. Alternatively, if the destination device is local to gateway 415, the server application handling the request may format the request to facilitate access to this local device.

Once the request message is formatted, or prior to formatting the request, in one embodiment, the server application may provide one or more commands that instruct the destination device to perform a selected process based on the type of server request received from the source device. For example, the server application may add instructions to the formatted server request specific to the destination device in accordance with the type of server request received.

Once the request is formatted and prepared, gateway 415 may send the request message to the destination device using on-board data link ports, using 220-1 to 220-N. The destination device may process the received request based on, for example, instructions included in the request provided by the server application. Alternatively, the destination device may be configured to process the received server request based on information provided by the source device. Once processed, the destination device may generate results (e.g., collected data from a memory, processed status data, processed sensor data, etc.). The destination device may then generate a response message including the results and send the message to gateway 415 in accordance with the protocol compatible with the data link connecting the destination device to gateway 415 (Step 560). In one embodiment, the response message may be a status message including information reflecting the status of the request, such as the availability of the destination device, successful downloads, acknowledgements, non-acknowledgments, etc. Alternatively, the response message includes the results of the processing performed based on the type of server request provided by the server application initially handling the request.

Gateway 415 may process the received response message and forward the results included therein to the appropriate server application responsible for processing the response message. The server application may be the same or a different server application that processed the request provided to the destination device. The server application may then process the results included and configure the response message to a format compatible with the data link used by the source device that provided the server request (Step 570). In one embodiment, the server application may leverage one or more of the inter-data link applications to configure the results into a response message compatible with the source device connecting data link. Gateway 415 may then use its communication software and hardware to deliver the message (Step 580).

In one embodiment, gateway 415 may deliver the response message to the source device over the same data link initially used by the source device. Alternatively, gateway 415 may deliver the response message to an off-board device over a different data link than that used by the source device providing the request. This may occur when the server request includes instructions to forward the response message to another off-board element based on the type of response data included in the response message. For example, gateway 415 may be configured with a server application that collects operations data from an on-board module, analyzes the data, and autonomously delivers the data, or a generated response message based on the data, to, for example, a third party off-board system.

Accordingly, gateway 415 may be configured with one or more server applications that process server requests based on the type of request and the information collected from a destination device. This allows work machine 410 to process server requests while stationed at, or if mobile, moving between, physical locations. Depending on the communication availability and capabilities of the data links interfacing gateway 415 (wireless or wireline), work machine 410 may provide network services to many different types of off-board systems. Further, the off-board server process may skip one or more of the steps described in connection with FIGS. 4 and 5 if gateway 415 determines they are unnecessary. For example, if a server request includes instructions to download information to a destination device (e.g., a memory location within or external to gateway 415), gateway 415 may not receive a response message that requires delivery. On the other hand, the destination device may be configured to provide an acknowledgement response message indicating the success or failure of the destination device downloading the information requested in the server request.

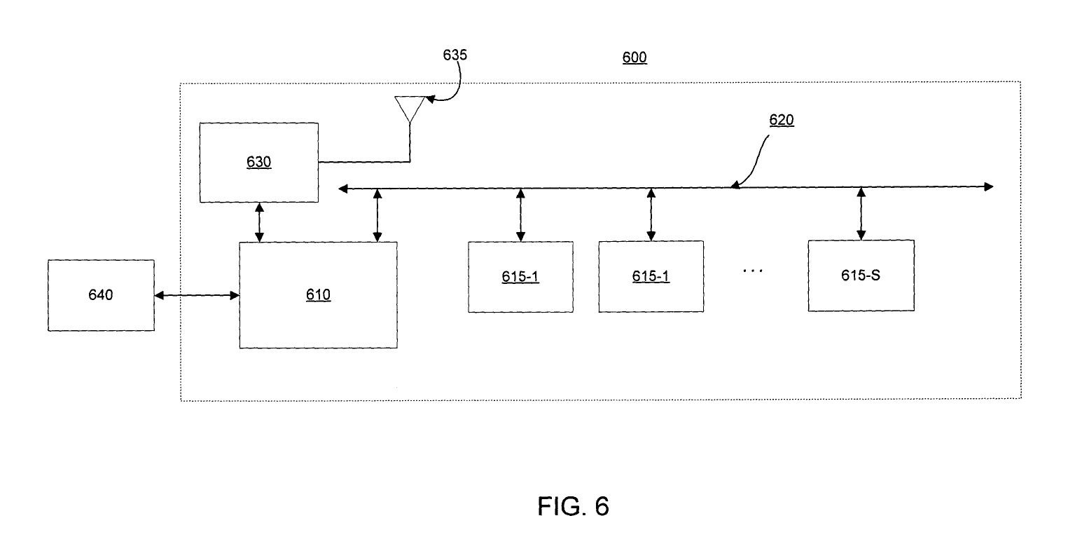

Although the off-board server process of FIGS. 4 and 5 describes a communication session initiated from an off-board source device, methods and systems consistent with embodiments of the present invention may perform similar processes when handling a request initiated by an on-board source device. FIG. 6 illustrates a block diagram of an on-board system 600 associated with a mobile work machine 605 consistent with certain embodiments of the present invention. As shown, work machine 605 includes a gateway 610 that is similar in configuration and operation as gateway 120 described above in connection with FIGS. 1 and 2. Further, work machine 605 includes one or more on-board modules 615-1 to 615-S connected to one or more data links 620. Modules 615-1 to 615-S may be any type of on-board module, component, or sub-component operating within work machine 605 and connected to one or more proprietary and/or non-proprietary data links. For example, modules 615-1 to 615-S may be ECMs, J1939 display devices (e.g., sensor gauges, etc.), EVIMs, on-board diagnostic systems, etc. Data links 620 may be one or more proprietary and/or non-proprietary data links similar to data links 128 and 129 described in connection with FIG. 1. Also, gateway 610 may be connected to one or more radio/modem interface devices 630 that transmits and receives information through one or more radio antennae 635 to one or more off-board devices, such as off-board computer system 140 described in connection with FIG. 1. Further, an off-board system 640 may also be connected to gateway 610 through an interface port (e.g., off-board data link ports 225-1 to 225-Y). In one embodiment, off-board system 640 may be a service interface system, similar to service port system 150 described in connection with FIG. 1.

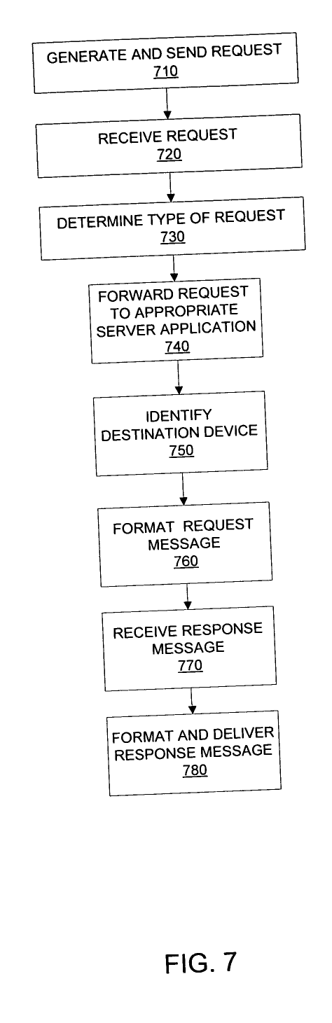

FIG. 7 illustrates a flowchart of an on-board server request process consistent with embodiments of the present invention. At step 710, an on-board source device (e.g., module 615-1) may generate and send a server request to gateway 610 over data link 620. Gateway 610 receives the request (Step 720) and determines the type of server request based on information included in the request message (Step 730). Based on the type of server request message, gateway 610 may forward the request to an appropriate server application that is configured to process the type of server request identified in Step 730 (Step 740). Accordingly, gateway 610 provides the request message to a server application that is running on the gateway device. The server application may extract the appropriate information from the request and processes the request to identify the destination device (e.g., on-board modules 615-1 to 615-S or an off-board system) for the request (Step 750). Based on the type of data link used by the identified destination device, the server application formats and sends the request to conform to the appropriate protocol used by the data link (e.g., proprietary, J1939, RS-232, etc.) (Step 760). As with the off-board server process, the server application processing an on-board server request may also include instructions that facilitate the processing of the request by the destination device. Further, the server application may leverage one or more of the inter-data link applications to format the server request in accordance with an appropriate protocol.

The destination device (e.g., on-board module 615-2, gateway process executed by the digital core 202, etc.) receives and processes the server request (Step 770) and may generate and send a response message to gateway 610 (Step 780). Gateway 610 may then deliver the response message including the results of the processed server request to the appropriate entity, such as the source device.

The on-board server process may skip one or more of the steps described in connection with FIG. 7 if gateway 610 determines they are unnecessary. For example, if a server request includes instructions to download information to a destination device (e.g., a memory location within or external to gateway 610), gateway 610 may not receive a response message that requires delivery. On the other hand, the destination device may be configured to provide an acknowledgement response message indicating the success or failure of the destination device downloading the information requested in the server request.

Embedded Web Server Applications

As described, a gateway configured in accordance with embodiments of the present invention may operate as a mobile server that manages and processes server requests from on-board and off-board systems. In addition to standard server capabilities, gateway 120 may be configured with a Web server application that generates and maintains one or more Web pages. The Web page may be an Hyper Text Markup Language (HTML) document that includes content reflecting various operating characteristics associated with the operations of the work machine hosting gateway 120. These operating characteristics may include Parameter Identification information (PIDs) associated with one or more work machine parameters, such as engine speed, temperature data, exhaust information, etc. These parameters may be included in one or more translation tables that are included in the inter-data link gateway applications 350 to convert information from a first protocol to a second protocol (e.g., proprietary data link to J1939, J1939 to Ethernet, etc.). Additionally, the characteristic information may include gateway performance information, such as software and/or hardware status information, state data, etc. Further, the Web page may include statistics and description information associated with one or more on-board components and modules operating within a work machine. Moreover, the Web page may include non-work machine characteristic information, such as hyperlinks to other Web pages maintained by remote Web servers, work machine manufacturing data maintained by a remote database system, etc. Also, the content included in the Web page may include configuration data associated with gateway 120's set-up.

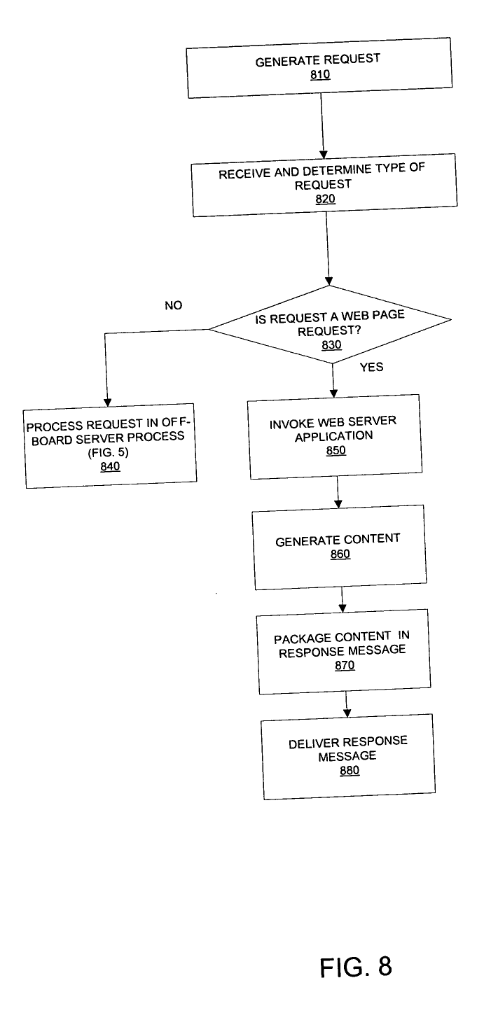

FIG. 8 illustrates a flowchart of an exemplary Web server process consistent with certain embodiments of the present invention. For exemplary purposes, the system shown in FIG. 1 will be referenced to describe the Web server process. The Web server process may begin when an off-board computer system (e.g., computer system 130 or computer system 140) requests access to the Web page maintained by gateway 120 (Step 810). The server request may be initiated or facilitated by Web browser software executing at the off-board computer system. Gateway 120 may receive and determine the type of request received in a manner similar to Step 520 of FIG. 5 (Step 820). If gateway 120 determines that the request is not a Web page request (Step 830—NO), the request is processed in a manner similar to the off-board server process described in connection with FIG. 5 (e.g., Steps 530-580) (FIG. 840). On the other hand, if the server request is a Web page access request (Step 830—YES), gateway 120 may invoke a Web server application to process the request (Step 850). In one embodiment, the Web page server application may access and render the Web page including content associated with the type of request provided by the off-board computer system (Step 860). Gateway 120 may then package the content into a response message compatible with the protocol used to communicate with the requesting off-board computer system, such as TCP/IP, HTTP, etc. (Step 870). At Step 880, gateway 120 delivers the response message to the off-board computer system where the content is rendered by the system's Web browser as a Web page.

In addition to providing access by off-board systems to the Web page, gateway 120 may update the content in the Web page based on information provided by one or more on-board modules 125, 127 or an off-board system 130, 140. For example, gateway 120 may be configured to receive requested, or non-solicited, data messages from one or more on-board modules (e.g., modules 125, 127) or off-board systems (e.g., systems 130, 140) including information associated with the respective modules or any sub-components controlled, monitored, or maintained by the module. Further, gateway 120 may receive sensor signal data from one or more sensors that are connected to gateway 120. The received information or data signal data may be extracted from a request message for updating the Web page content by the Web server application. The application may use the extracted information to modify the content of the Web page, such as updating data values, modifying parameter information, status information, and system configuration information, etc. Accordingly, an off-board system, user, etc. may retrieve updated work machine related information over the Internet that is automatically updated by gateway 120.

Communication Applications

As explained, gateway 120 includes one or more communication applications that are leveraged by sister applications to control communication processes between data links. In one embodiment, gateway 120 may perform protocol translation processes to facilitate communications between different types of data links, whether on-board or off-board. As used herein, the term “translation” refers to converting messages from one data link protocol into comparable messages of another protocol. For example, data messages including PID information may be translated from an off-board data link protocol (e.g., Ethernet) into data values compatible with an on-board data link protocol (e.g., J1939). The PIDs may be associated with one or more operational parameters of work machine 105, such as engine speed, injection rates, component and/or area temperatures, pressures, etc. corresponding to systems, modules, and components located on work machine 105. Further, the parameters may be associated with engine diagnostic and performance parameters associated with an ECM. A data message may include one or more commands to adjust a PID data value based on a requested action directed to work machine 105. For example, a data message may include a request to increase the engine speed of work machine 105 by adjusting the data values associated with the PID corresponding to engine RPMs.

Consistent with principles of the present invention, a communication application may perform translating processes for any number of protocols. Messages from multiple and different data links may be discretely or simultaneously translated and sent out on a single data link. Messages may also be received from a single data link and discretely or simultaneously translated and sent out over multiple and different data links. Non-limiting examples of translations include: (1) CDL and J1939 to MODBUS; (2) CDL to ISO11783; (3) CDL to J1939; (4) ATA to J1939; and vice versa.

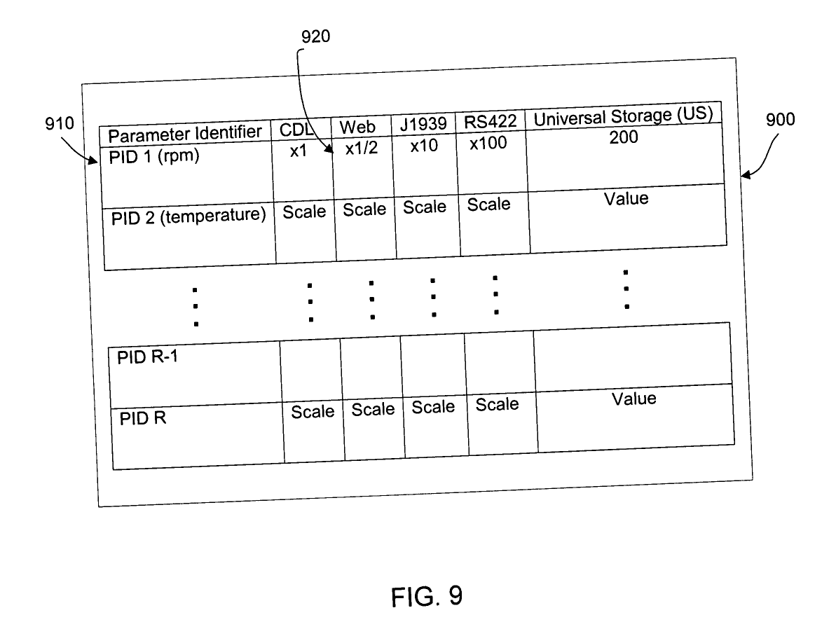

Consistent with principles of the present invention, gateway may maintain a translation data structure, such as a translation table, that maps parameters between data links for facilitating protocol translations. Gateway 120 may access the translation table in order to convert information (e.g., PID data values) from one protocol compatible data value to another. FIG. 9 illustrates an exemplary translation table 900 consistent with embodiments of the present invention. In certain embodiments, translation table 900 may be stored in a memory device within gateway 120, such as memory 210, and accessed by processor 202. As illustrated in FIG. 9, translation table 900 may include a plurality of parameter identifiers (PIDs) 910 representing system parameters associated with various data link protocols. For example, PID 1 may represent an engine speed (RPM) parameter associated with certain protocols. PID 2 may, as illustrated, represent a temperature parameter. Table 900 may include any number (N) of different PIDs.

Table 900 may also include one or more scaling factors 920, each representing a data link “view.” Each view may correspond to a particular protocol interfaced by gateway 120. Exemplary table 900 includes four views: (1) a proprietary data link (CDL) view; (2) an Ethernet data link (i.e., Web) view; (3) a J1939 view; and (4) a RS-422 view. Although four views are shown, table 900 may include any number of views corresponding to data links interfaced by gateway 120. Each “view” may enable its associated data link to interpret parameter data stored in a universal storage location. Universal Storage (US) represents a memory location or locations that store one or more values corresponding to a particular parameter (i.e., parameter data). Parameter data may be received from one or more data links interfaced by gateway 120.

As illustrated in FIG. 9, each data link view may include a scale factor corresponding to translation logic used by gateway 120 to translate parameter data stored in the US to an appropriate format for the particular data link protocol. In certain embodiments, all views represented by translation table 900 may support a given parameter. For example, an RPM parameter (PID 1) may exist in all of the protocols mapped by translation table 900 (e.g., CDL, Web, J1939, and RS-422). In some cases, however, certain parameters may be supported by less than all of the views mapped by translation table 900. For example, the temperature parameter may be supported by CDL, Ethernet, and J1939 but not by RS-422. The scale factor for such non-supporting views may be null or set to zero.

In addition, each view in translation table 900 may include a specific read/write privilege to the Universal Storage. That is, certain data links may be assigned write privileges to the Universal Storage, while other data links have only read access.

Consistent with translating processes of the present invention, translation table 900 may be pre-configured with a plurality of parameter identifiers and scale factors corresponding to a plurality of data links interfaced by gateway 120. In operation, gateway 120 may receive a message, including a PID and corresponding parameter data, from a particular data link. In response to such a message, gateway 120 may extract the PID and store the parameter data in the US. In addition, gateway 120 may use the PID to scale the parameter data according to the scale factors included in translation table 900, thereby creating multiple “views” of the parameter data. In one example, gateway 120 may receive a request for parameter data from a particular data link. The request may include a PID corresponding to the requested data. In response to such a request, gateway 120 may extract the PID from the request and scale the requested parameter data (previously stored in the US) using a scale factor corresponding to the extracted PID and requesting data link protocol.

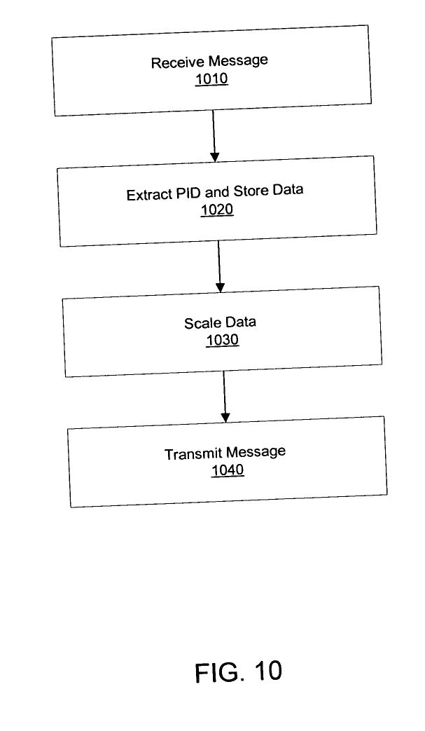

FIG. 10 is a flowchart depicting an exemplary translation process consistent with embodiments of the present invention. The illustrated process may begin when gateway 120 receives a message from a source (Step 1010). For example, on-board module 125 (e.g., an ECM) may provide gateway 120 with a proprietary data link message destined for computer system 130. The received message may include one or more parameters with corresponding parameter data. The received message may also indicate one or more destination devices for the parameter data included in the message. In certain embodiments, the received message may serve to transmit parameter data from a source device to a destination device. In one example, on-board module 125 may send gateway 120 a message over proprietary data link 128 including a PID corresponding to engine speed (e.g., RPMs) and a corresponding PID data value representing actual engine speed, such as 100 RPMs. The PID data, however, may be configured in a format consistent with data link 128. For example, although the actual engine speed reported by module 125 may be 100 RPMs, the module may transmit information that is numerically (or textually, symbolically, etc.) different from the actual value, such as the value 200. Because other data links (e.g., non-proprietary data link 129) may be sending the engine speed data to other on-board modules in work machine 105, the transmitted PID data value cannot be used by gateway 120 and the on-board module without detrimental affects on the performance and/or operations of work machine 105. Accordingly, these PID data values need to be translated to appropriate protocol compatible data values.

Upon receiving the message from the source device, gateway 120 may extract the PID from the message and store the corresponding parameter data (e.g., 200) in the Universal Storage location (Step 1020). As mentioned above, methods and systems consistent with the present invention may enable multiple and different data links to access data stored in the US. In one example, translation table 900 may allow various views (e.g., Web, J 1939, CDL, etc. ) to access the stored RPM data.

Further, gateway 120 may scale the parameter data in the received message from the source to conform with the destination protocol (Step 1030). For example, if the destination for the parameter value is a Web-based module, gateway 120 may use a scale factor from translation table 910 corresponding to the Web view. Gateway 120 may identify and select an appropriate scale factor based on the PID corresponding to the parameter data and destination protocol. For example, gateway 120 may scale RPM data for an Ethernet protocol by retrieving a scale factor that corresponds to the Web view and the RPM PID. Referring to the exemplary value depicted in FIG. 9, for the Web the RPM parameter data may be scaled by one-half (½) in order to retrieve the actual RPM value of 100. In another example, the RPM parameter data may be scaled by ten (10) in order to provide a J1939 module with the actual parameter data. That is, 2000 may correspond to an actual RPM value of 100 in the J1939 protocol.

After scaling the parameter value, gateway 120 may transmit (e.g., via a message) the scaled parameter value to its destination via the data link associated with the destination device (Step 1040). For example, gateway 120 may transmit the scaled RPM parameter value to off-board computer system 130 via an Ethernet data link.

Although the process of FIG. 10 refers to specific source and destination devices, translation processes consistent with the present invention may enable multiple and different processes associated with the various data links “views” to access (discretely and simultaneously) data from the US location. For example, gateway 120 may receive RPM data periodically from an ECM, and a plurality of other modules may periodically access the data from gateway 120 via translation table 900. In such scenarios, gateway 120 could receive a request, including a particular PID, from a data link for a parameter value corresponding to the PID. In response to such a request, gateway 120 may use the received PID to select an appropriate scale factor for the requesting data link and provide that data link with access to the parameter data from the US. The gateway may, for example, send a message to the requesting data link that includes the scaled parameter data. Further, gateway 120 could be configured to translate and transmit parameter data to several modules, dynamically or periodically. Additionally, a particular view may access information and provide feedback forming a closed loop operation. In one instance, a J1939 module may receive RPM data from gateway 120 and, in response, provide a command destined for a proprietary data link-based ECM to increase engine speed. Such a command may be routed to gateway 120, where it is translated and sent to the ECM.

As described above, each data link view in translation table 900 may include its own read/write privileges to the Universal Storage. Thus, in the above example, the Web browser may not be permitted to overwrite the parameter value in the Universal Storage. To accommodate feedback from modules, translation table 900 may include multiple US locations corresponding to a given parameter and mapped to corresponding scale factors. For instance, if an off-board computer system receives parameter data from a first US location and then provides feedback information based on the received data, gateway 120 may store that feedback information in a second US location associated with the parameter. The stored feedback may be then scaled to a format corresponding to the data link connected to original sending module. Gateway 120 may then send the scaled data to the on-board system module for processing. In one example, a proprietary data link-based ECM may provide gateway 120 with fuel flow data. Gateway 120 may translate and route this parameter data to a diagnostic module via an Ethernet data link. Upon receipt, the diagnostic module may provide feedback to gateway which includes instructions to increase the fuel flow rate. This feedback may be stored in translation table 900, scaled, and transmitted back to the ECM for processing. In response to receiving the feedback, the ECM may increase the fuel flow rate in accordance with the message from the diagnostic module.

Firewall Server Applications

In another embodiment, gateway 120 may include a security application that operates as a firewall for controlling access to information, data links, and resources located in work machine 105. For example, by executing the security application, gateway 120 allows authorized off-board systems to collect information, modify parameters, and control a work machine through gateway 120, while unauthorized systems are prevented from doing the same. This feature allows gateway 120 to protect proprietary data associated with work machine 105 that should be shielded from unauthorized systems and/or users, while allowing authorized systems, processes, and/or users access to the same data. Also, the security application may be configured restrict access to particular data links based on some criteria in addition to limiting to access to data on a link. For example, gateway 120 may be configured to restrict access to on-board MODBUS data links from selected off-board systems, such as an off-board computer system or particular types of remote work machines, etc.

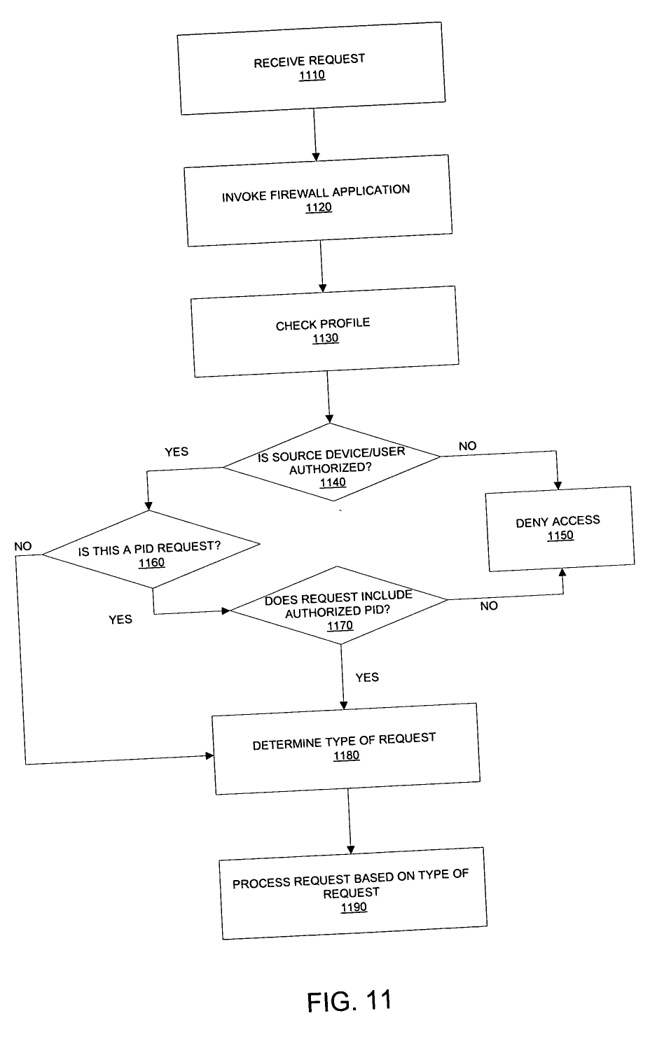

The proprietary data protected by the gateway firewall may include, for example, the PID information specific to the operational parameters of work machine 105, such as engine speed, injection rates, component and/or area temperatures, pressures, etc. Based on the relationship between the proprietary data and work machine 105, gateway 120 may be configured to protect this information using the PID information itself as a security mechanism. FIG. 11 illustrates an exemplary firewall application process consistent with certain embodiments related to the present invention. For exemplary purposes, the firewall application process will be described with reference to FIGS. 1 and 9.

Initially, an off-board system (e.g., off-board system 130, 140, 150) may generate a request directed to work machine 105. The request may be any type of request capable of being processed by gateway 120 and/or any on-board modules included in on-board system 110. For example, the request may be a server request, a Web server request or a request for modifying an operating characteristic of work machine 105. The latter request may be a feature that is useful in remote control operations of work machine 105. For example, off-board computing system 140 may generate a request message including a command for changing a parameter data value for a particular parameter. In this case, the command may include a PID that identifies the particular parameter targeted for adjustment and a corresponding adjustment value. For example, the command may request that work machine 105 increase its engine speed from 100 RPMs to 200 RPMs.

The off-board system may then send the request to gateway 120 over an appropriate off-board data link where it is received through a corresponding off-board data link port 225-1 to 225-Y (Step 1110). In response to the request, gateway 120, either through a communication application or other form of logic, software, hardware, etc., invokes the firewall application (Step 1120).

Based on the configuration of the firewall application, a first level of security is checked. In one embodiment, the first level of security may include checking the profile of the source of the request, which in this example is off-board system 140 (Step 1130). A profile is a map of access permissions for different types of users and/or systems providing requests to gateway 120. For example, various levels of access may be defined for different types of users operating off-board system 140. The profiles may, for example, include a customer, super customer, dealer, engineering, technician, and administrative access levels. A customer profile may be associated with an access level provided to customers of a manufacturer of work machine 105. Users with a customer profile may have limited access to certain information maintained in work machine 105, such as read-only access to PID information. A super customer profile may be associated with customers with a higher level of access to a larger set of work machine information and/or control, such as adjusting parameter data values. A dealer profile may be associated with users that have limited access to work machine statistic information, such as position, hours operated, etc. An engineering profile is associated with users with another level of access to additional work machine information that allow the user to adjust the design of new versions of work machines based on the operating characteristics of work machine 105and have the ability to change values in memory registers or processor tasks. A technician profile may be associated with users that have access to many or all of work machine 105's operational data, such as gauge data values, temperature, load information, etc and have the ability to flash new software files and update configuration or data files. And, the administrative profile may be associated with a user having the highest level of access to work machine information, such as the ability to redefine, delete, and add PIDs. It will be appreciated that the afore-mentioned profiles are exemplary and that any number of different profile may be supported by gateway 120.

Referring back to FIG. 11, the firewall application may determine whether the source device (e.g., off-board system 140) and/or the user operating the device is authorized to communicate to gateway 120 (Step 1140). If the request is not authorized (Step 1140—NO), the firewall application may deny access to the requested information and/or service provided by gateway 120, and the application may provide a response message indicating the failure of the request and the process ends (Step 1150).

On the other hand, if the source device and/or user is authorized to communicate with gateway 120 (Step 1140—YES), the firewall application may determine whether the request is a PID request, such as an instruction to adjust, add, delete, etc. a PID or parameter data value (Step 1160). If the request is not a request is not a PID request (Step 1160—NO), the process continues to Step 1180, described below.

If, however, the request is a PID request (Step 1160—YES), the firewall application may determine whether the request includes an authorized PID (Step 1170). In one embodiment, the firewall application may access translation table 900 to determine whether the PID included in the request matches any of the PIDs 910 included in table 900. If so, the request is authorized (Step 1170—YES). If not, the request is not authorized (Step 1170—NO) and the request is denied (Step 1150).

If the PID is an authorized identifier (i.e., included in table 900), the firewall application may then determine the type of request provided by the source device/user (Step 1180). Based on the type of request, the firewall application process may forward the request to the appropriate application (e.g., server application, Web server application, communication application, etc.) for processing in accordance with the processes described above in connection with FIGS. 5, 7, 8, and 10 (Step 1190). In one embodiment, the type of request may include a command to modify a parameter identifier data value in the translation table. Further, the request may include a command to add or delete a parameter identifier in the translation table. Moreover, the request may include a command to access information stored in an on-board module located on one or more on-board data links (e.g., data links 128, 129).

It will be appreciated that the request may include commands or instructions for a number of different tasks, including, but not limited to, downloading information from work machine 105, pushing information to work machine 105, modifying information in work machine 105, controlling components or on-board modules of work machine 105, etc.

By executing a firewall application in a manner consistent with the embodiments described above, gateway 120 may protect proprietary information (e.g., PIDs 910) from unauthorized access and manipulation. In another embodiment, gateway 120 may store a data structure (e.g., separate table) that includes a list of authorized PIDs that may be accessed and/or controlled by authorized off-board systems or users. For example, the firewall application may allow implementation of a Virtual Private Network (VPN) connection to securely connect a work machine to remotely located host computers over the Internet.

In another embodiment of the present invention, if a request is bundled with multiple commands, (e.g., 5 commands with 5 PIDs), gateway 120 may determine whether any or all of the PIDs in the request have corresponding identifiers 910 in translation table 900. As a result, gateway 120 may allow a subset of the 5 commands (e.g., 3 out of the 5 command) to be processed based on the number of valid PIDs in the bundled message.

Industrial Applicability

Methods and systems consistent with embodiments of the present invention allow work machines to operate as servers that manage data and network services for one or more networks consisting of fixed and/or mobile work machines, on-board modules, and/or off-board systems. In one embodiment, a work machine configured with a gateway 120 may include firewall application software that operates as a firewall server protecting proprietary information corresponding to the work machine. Using proprietary information as an access checking mechanism, gateway 120 provides multiple levels of security for work machine 105 and any of its information maintained within the machine.

In another embodiment of the present invention, the firewall application may be configured to control access to proprietary information based on a timing profile. For example, in the event some work machine 105 proprietary information is time valued, the firewall application may adjust access by off-board systems in accordance with the intervals the information is needed and/or requested. For example, a request to monitor a fuel line may require feedback at quicker intervals than a request to monitor tire pressure. Accordingly, gateway 120 may limit access to certain PIDs and corresponding parameter information based on the type of time-valued request, thus allowing higher prioritized requests to be serviced by the firewall application before other requests.

Further, the firewall application may control access to information stored in gateway 120 and/or other on-board modules in on-board system 110 by one or more on-board modules or components. Accordingly, the firewall process may determine whether a request is received from an on-board data link or an off-board data link, and adjusts access to targeted information based on this determination.

In a wireless setting, gateway 120 may execute the firewall application in a mobile work machine that moves between, or within, work environments such that the gateway acts as a mobile firewall for information external to work machine 105. For example, work machine 105 may be acting as a mobile access point in a wireless network that includes one or more mobile and/or fixed work machines. In such a configuration, work machine 105 may receive a request from one of the other work machines for information maintained in a remote location, such as another work machine, an off-board computing system, etc. The firewall application in gateway 120 may deny the request (e.g., prevent access, etc.) based on an authorization level of the requesting work machine, the type of request, and the type of information located in the remote location. Further, the firewall application may control access to proprietary information located in a remote location based on the position of the work machine. Accordingly, work machine 105 may be positioned in an environment to provide mobile and perhaps temporary security functions by intercepting requests for proprietary information maintained in a remote site in communication with gateway 120 of the work machine.

The embodiments, features, aspects and principles of the present invention may be implemented in various environments and are not limited to work site environments. For example, a work machine with an embedded gateway may perform the functions described herein in other environments, such as mobile environments between job sites, geographical locations and settings. Further, the processes disclosed herein are not inherently related to any particular system, and may be implemented by a suitable combination of electrical-based components. Other embodiments of the invention will be apparent to those skilled in the art from consideration of the specification and practice of the invention disclosed herein. It is intended that the specification and examples be considered as exemplary only, with a true scope of the invention being indicated by the following claims.

1. A system for managing communications between one or more on-board modules associated with a work machine and connected to one or more on-board data links and one or more off-board systems connected to one or more off-board data links, the system comprising:
a first off-board system connected to a first off-board data link, wherein the off-board module is remotely located from the work machine; and
a gateway embedded in the work machine including:
a communication application that uses a translation table stored in the gateway for converting information from a first protocol format to a second protocol format, and
a firewall application that is configured to perform, when executed by a processor, a firewall process that controls access to proprietary information associated with the work machine,
wherein the firewall process determines whether a message received from the first off-board system is authorized based on a profile associated with the first off-board system, whether a message received from the first off-board module includes a parameter identifier corresponding to one of a number of parameter identifiers included in the translation table, and denies access to the proprietary information based on at least one of (i) a determination that the parameter identifier in the data message does not correspond to one of the number of parameter identifiers in the translation table and (ii) the profile associated with the off-board system.

2. The system of claim 1, wherein the firewall process denies or grants access to the proprietary information based on a profile associated with a user operating the first off-board system.

3. The system of claim 1, wherein the profile is associated with a user of the off-board system and defines a type of access to a selected portion of the proprietary information.

4. The system of claim 1, wherein the proprietary information includes a parameter identifier data value.

5. The system of claim 1, wherein the firewall process allows the first off-board system to access the proprietary information when the parameter identifier in the message matches at least one parameter identifier included in the translation table.

6. The system of claim 5, wherein the gateway executes the communication application to convert the request to a different protocol format when the firewall process allows the off-board system to access the proprietary information.

7. The system of claim 1, wherein the firewall process denies access to an on-board module based on parameter information included in a second message.

8. The system of claim 1, wherein the work machine moves between, or within, a work environment and the firewall application controls access to proprietary information located in a remote location based on the position of the work machine.

9. The system of claim 8, wherein the gateway receives the message from a second gateway included in the second work machine that has moved into communication range of the work machine.

10. The system of claim 1, wherein the firewall application performs a second firewall process that controls access to the proprietary information based on a timing profile associated with the type of request.

11. The system of claim 1, wherein the request is a batch request including multiple sub-requests associated with the proprietary information, and the firewall process denies access to a-portion of the proprietary information based on a determination that parameter identifiers associated with a respective portion of the sub-requests do not match any of the parameter identifiers included in the translation table.

12. A method for managing communications in an environment including a work machine having one or more on-board data links connected to one or more on-board modules and a gateway, and one or more off-board data links connected to one or more off-board systems and the gateway, the method performed by the gateway comprising:
receiving a request generated by a first off-board system and transmitted on a first off-board data link; and
invoking a firewall application that performs a firewall process including the steps of:
identifying a destination device associated with the request,
determining whether the request is authorized based on a profile associated with the first off-board system,
determining whether the request includes a parameter identifier that matches a parameter identifier included in a memory location maintained by the gateway, and
denying or granting access to proprietary information based on the two determining steps.

13. The method of claim 12, wherein the profile is associated with a user of the off-board system and defines a type of access to a selected portion of the proprietary information.

14. The method of claim 12, wherein the proprietary information includes a parameter identifier data value.

15. The method of claim 12, wherein the firewall process allows the first off-board system to access the proprietary information when the parameter identifier in the request matches at least one parameter identifier included in the memory location.

16. The method of claim 12, wherein the gateway executes a communication application to convert the request to a different protocol format when the firewall process allows the off-board system to access the proprietary information.

17. The method of claim 16, wherein the memory location is included in a translation table used by the communication application to convert parameter data values to different formats.

18. The method of claim 12, wherein the firewall process denies access to an on-board module based on parameter information included in a second request.

19. The method of claim 16, wherein the work machine moves between, or within, a work environment and the method further includes:
controlling access to proprietary information located in a remote location based on the position of the work machine.

20. The method of claim 19, wherein the gateway receives the request from a second gateway included in a second work machine that has moved into communication range of the work machine.

21. The method of claim 12, wherein the method further includes:
controlling access to the proprietary information based on a timing profile associated with the type of request.

22. The method of claim 12, wherein the request is a batch request including multiple sub-requests associated with the proprietary information, and the firewall process further includes:
denying access to a portion of the proprietary information based on a determination that parameter identifiers associated with a respective portion of the sub-requests do not match a parameter identifier included in the memory location.

23. A computer-readable medium including instruction for performing, when executed by a processor, a method for managing communications in an environment including a work machine having one or more on-board data links connected to one or more on-board modules and a gateway, and one or more off-board data links connected to one or more off-board systems and the gateway, the method performed by the gateway comprising:
receiving a request generated by a first off-board system and transmitted on a first off-board data link; and
invoking a firewall application that performs a firewall process including the steps of:
identifying a destination device associated with the request,
determining whether the request is authorized based on a profile associated with the first off-board system,
determining whether the request includes a parameter identifier that matches a parameter identifier included in a memory location maintained by the gateway, and
denying or granting access to proprietary information based on the two determining steps.
